(19) United States
(12) Patent Application Publication
(10) Pub. No.: US 2022/0015108 A1
(43) Pub. Date: Jan. 13, 2022

(54) Wireless Communication Module Event Selection

(71) Applicant: Imagination Technologies Limited, Kings Langley (GB)

(72) Inventor: Andrew Scott-Jones, Hertfordshire (GB)

(21) Appl. No.: 17/345,112

(22) Filed: Jun. 11, 2021

(30) Foreign Application Priority Data
Jun. 11, 2020 (GB) 2008842.3

(51) Int. Cl. H04W 72/12

(52) U.S. Cl. CPC H04W 72/12

(57) ABSTRACT

A mechanism for efficient event scheduling for a wireless communication module. The event scheduling is performed by employing a tree-based structure for organising/arranging desired events by desired initiation time, and selecting an event to be performed by the wireless communication module using the tree-based structure. Conflicting events are resolved using a probabilistic scheduling approach.

### BACKGROUND

The use of wireless communication modules to facilitate communication between two (wireless) devices is increasing. When operating, a wireless communication module needs to perform a wide variety of communication tasks or “events”, such as scanning for other devices, broadcasting identifying information, maintaining open communication channels or passing information over an open communication channel.

The communication hardware, such as an antenna, of a wireless communication module may only be capable of carrying out a limited number of events at any given point in time. In particular, some examples of communication hardware may only be capable of performing a single event at a time.

There is therefore a need for an event scheduler that schedules or selects events to be carried out by the wireless communication module.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

There is proposed a mechanism for efficient event scheduling for a wireless communication module. The event scheduling is performed by employing a tree-based structure for organising/arranging desired events by desired initiation time, and selecting an event to be performed by the wireless communication module using the tree-based structure. Conflicting events are resolved using a probabilistic scheduling approach.

According to the present disclosure, there is provided a computer-implemented method of selecting an event to be carried out by a wireless communication module during a first period of time.

The computer-implemented method comprises performing, using an event scheduler, steps of: obtaining a desired event dataset comprising two or more desired events arranged in a tree-based data structure based on a desired initiation time for each desired event; processing the desired event dataset to identify which, if any, desired events have a desired initiation time falling within the first period of time; and in response to two or more desired events, in the desired event dataset, having a desired initiation time falling within the first period of time, performing a probabilistic scheduling algorithm on the identified desired events to select the event to be carried out by the wireless communication module.

The step of obtaining the desired event dataset may comprise receiving one or more desired events and generating or modifying, using the event scheduler, a desired event dataset to include the received one or more desired events, wherein the generating or modifying of the desired event dataset is performed based on a desired initiation time for each received one or more desired events.

In some embodiments, each desired event is associated with a weighting that affects a probability that the said desired event will be selected by the probabilistic scheduling algorithm; and the probabilistic scheduling algorithm uses the weighting of each of the identified desired events to select the event to be carried out by the wireless communication module.

The computer-implemented method may further comprise monitoring a time since last performance of a desired event by the wireless communication module; and in response to the time exceeding a predetermined value, modifying the weighting of the desired event to increase the probability that the said desired event will be selected by the probabilistic scheduling algorithm.

The probabilistic scheduling algorithm may be a lottery scheduling algorithm.

In some embodiments, the method further comprises in response to only a single desired event having a desired initiation time falling within the first period of time, selecting the single desired event as the event to be carried out by the wireless communication module.

In some embodiments, in response to no desired event having a desired initiation time falling within the first period of time, the method performs a step of selecting no desired event as the event to be carried out by the wireless communication module.

There is also proposed a computer-implemented method of selecting an event to be carried out be a wireless communication module. The computer-implemented method comprises receiving an event request, the event request being a request for a selection of an event to be performed by the wireless communication module during a desired period of time; and performing any previously described method, wherein the first period of time is the desired period of time indicated by the event request.

An event may be a communication task to be carried out by the wireless communication module. The wireless communication module may operate according to a Bluetooth® standard.

There is also proposed a computer-implemented method of controlling an event performed by a wireless communication module, the computer-implemented method comprising: receiving, at the wireless communication module, a selection of a desired event from an event scheduler, wherein the event scheduler selects the desired event by performing any previously described method; and carrying out, by the wireless communication module, the desired event indicated by the selection of the desired event.

There is also proposed a computer-implemented method of controlling an event performed by a wireless communication module, wherein each event is associated with a priority. The computer-implemented method comprises: receiving, at the wireless communication module, a selection of a desired event from an event scheduler, wherein the event scheduler selects the desired event by performing a previously described method; comparing, using the wireless communication module, a priority of the selected desired event to an ongoing event being performed by the wireless communication module; in response to the priority of the ongoing event being greater than the priority of the selected desired event, continuing with the ongoing event; and in response to the priority of the selected desired event being greater than the priority of the ongoing event, suspending or aborting the ongoing event and performing the selected desired event.

There is also proposed an event scheduler configured to select an event to be carried out by a wireless communication module during a first period of time. The event scheduler being configured to perform steps of: obtaining a desired event dataset comprising two or more desired events arranged in a tree-based data structure based on a desired initiation time for each desired event; processing the desired event dataset to identify which, if any, desired events have a desired initiation time falling within the first period of time; and in response to two or more desired events, in the desired event dataset, having a desired initiation time falling within the first period of time, performing a probabilistic scheduling algorithm on the identified desired events to select the event to be carried out by the wireless communication module.

There is also proposed an event scheduler configured to perform a previously described method.

There is also proposed a wireless communication module configured to carry out one or more events to wirelessly communicate with other wireless communication modules. The wireless communication module is configured to perform steps of: receiving a selection of a desired event from an event scheduler previously described; and carrying out the desired event indicated by the selection of the desired event.

There is also proposed a wireless communication module configured to carry out one or more events to wirelessly communicate with other wireless communication modules, wherein each event is associated with a priority, the wireless communication module being configured to perform steps of: receiving a selection of a desired event from a previously described event scheduler; comparing a priority of the selected desired event to an ongoing event being performed by the wireless communication module; in response to the priority of the ongoing event being greater than the priority of the selected desired event, continuing with the ongoing event; and in response to the priority of the selected desired event being greater than the priority of the ongoing event, suspending or aborting the ongoing event and performing the selected desired event.

There is also proposed a wireless communication system comprising a previously described event scheduler and a previously described wireless communication module. There may also be a wireless communication system configured to perform a previously described method.

The wireless communication module may be embodied in hardware on an integrated circuit. There may be provided a method of manufacturing, at an integrated circuit manufacturing system, a wireless communication system. There may be provided an integrated circuit definition dataset that, when processed in an integrated circuit manufacturing system, configures the system to manufacture a wireless communication system. There may be provided a non-transitory computer readable storage medium having stored thereon a computer readable description of a wireless communication system that, when processed in an integrated circuit manufacturing system, causes the integrated circuit manufacturing system to manufacture an integrated circuit embodying a wireless communication system.

There may be provided an integrated circuit manufacturing system comprising: a non-transitory computer readable storage medium having stored thereon a computer readable description of the wireless communication system; a layout processing system configured to process the computer readable description so as to generate a circuit layout description of an integrated circuit embodying the wireless communication system; and an integrated circuit generation system configured to manufacture the wireless communication system according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 illustrates a wireless communication system;

FIG. 2 is a flowchart illustrating a method;

FIG. 3 is a flowchart illustrating another method;

FIG. 4 illustrates a tree-based data structure;

FIG. 5 shows a computer system in which a wireless communication system is implemented; and

FIG. 6 shows an integrated circuit manufacturing system for generating an integrated circuit embodying a wireless communication system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

The present disclosure relates to the scheduling of events to be performed by a wireless communication module. In the context of the present disclosure, an event is a task or process to be performed by the wireless communication module on behalf of the device containing the wireless communication module.

A wireless communication module may comprise wireless communication hardware, such as one or more antennae, for carrying out a task or event.

Suitable examples of events include scanning for other (wireless) devices, broadcasting identifying information of the (wireless) device, maintaining open communication channels or passing information over an open communication channel. The precise process performed when carrying out an event may depend upon the wireless communication protocol employed by the wireless communication module.

Suitable wireless communication protocols that may be used by a wireless communication module when carrying out an event include an infrared link, ZigBee®, Bluetooth®, a wireless local area network protocol such as in accordance with the IEEE® 802.11 standards, a 2G, 3G, 4G, or 5G telecommunication protocol, a near-field communication (NFC) protocol and so on. Other formats will be readily apparent to the person skilled in the art, and may include communication protocols yet to be developed.

The present disclosure is most suited to more complex communication standards in which a device may wish to perform multiple events using the wireless communication module (e.g. communicate with multiple other devices simultaneously).

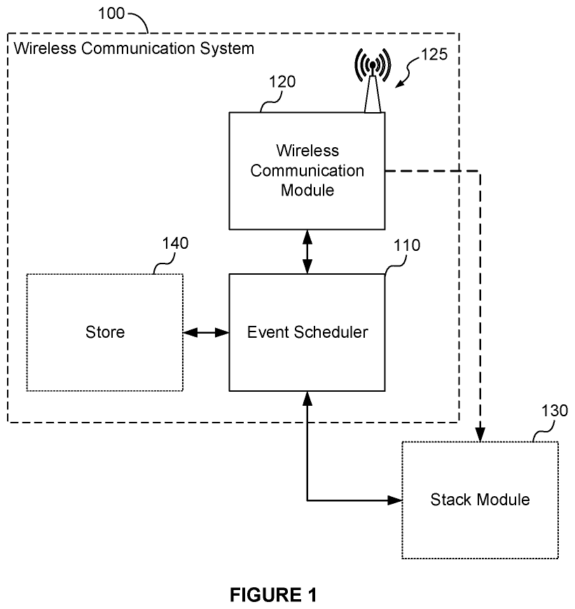

FIG. 1 is a block diagram illustrating a wireless communication system 100 for understanding a context of proposed embodiments. The wireless communication system 100 forms an aspect of a larger (wireless) device (not fully illustrated) and handles wireless communication tasks or events for the device. Suitable examples of such larger (wireless) devices include cellular devices, laptops, computers, tablets, smart phones, smart watches and so on.

The wireless communication system 100 comprises an event scheduler 110 and a wireless communication module 120. The wireless communication module 120 carries out (i.e. performs or executes) events or tasks for communicating with other (wireless) devices, e.g. using wireless communication hardware such as an antenna 125. The event scheduler 110 selects/identifies/schedules events to be carried out by the wireless communication module 120.

The event scheduler 110 may be configured to receive incoming desired events, being events that other components of the wireless device wish the wireless communication module 120 to carry out. These incoming desired events may, for example, be submitted to the event scheduler by a stack module 130 or another component of the wireless device.

Each event is associated with a desired initiation time, indicating a time at which it is desired for the event to be carried out by the wireless communication device 120. Information on the desired initiation time may be stored as a data element of the event itself. The desired initiation time may, for example, be defined by the other components of the wireless device (e.g. in their communication with the event scheduler 110) and/or result from a negotiation between the event scheduler and the other devices. Other methods of defining a desired initiation time for an event will be apparent to the skilled person.

In the context of the present disclosure, an event may comprise an instruction or indication of a task to be carried out, e.g. be some data that can be used by the wireless communication module to perform a task. The event may comprise, for example, an instruction for performing a tasks (e.g. code that defines a task to be performed) or a value indicating a predetermined task that could be carried out by the wireless communication module 120. The skilled person would be readily capable of determining the content of an event.

The event scheduler 110 arranges obtained desired events into a searchable data structure. In the present disclosure, the event scheduler 110 arranges desired events into a tree-based data structure (or “tree”) based on the desired initiation time for each desired event.

The event scheduler 110 selects an event to be carried out by the wireless communication module 120 during a particular time period. This “particular time period” may represent a clock cycle (or set of clock cycles) of the wireless communication module. In particular, the particular time period may represent a future clock cycle or set of clock cycles of the wireless communication module, to plan an event to be performed by the wireless communication module in the future.

Selection of any event may be performed by selecting a desired event having a desired initiation time falling within the particular time period as the event to be carried out by the wireless communication module. The wireless communication module 120 may then receive an indication of the selected desired event and carry out the indicated event.

A conflict can arise in the event scheduler 110 if more than one desired event has a desired initiation time falling within the particular time period, i.e. if a group of two or more desired events all wish to be initiated or performed at approximately the same time. This results in “conflicting desired events”, being desired events that all wish to be performed during the same particular time period.

In these circumstances, it is recognised that it would be beneficial if the event scheduler were able to decide which of the conflicting desired events is to be performed by the wireless communication module.

In the present disclosure, the event scheduler 110 performs a probabilistic scheduling algorithm to select which conflicting desired event is to be performed by the wireless communication module. Thus, rather than using a priority-based approach for selecting a conflicting event, a probabilistic approach is used. This means that all conflicting events have a chance to be selected as the event to be performed by the wireless communication module 120, thereby reducing a likelihood of event starvation occurring.

In some examples, each desired event may be associated with a weighting that affects the probability that the said desired event will be selected by the probabilistic scheduling algorithm. The weighting may, for example, be a number or value.

The weighting may be defined, for example, by an operator of the device or set according to some wireless communication protocols. The weighting for an event may vary depending upon the (type of) event or time since last execution of the event, as will be later explained. The weighting may be a value falling within a predetermined range.

Conceptually, the weighting may represent a perceived importance or “priority” of that event. It may be analogous to a historic concept of “priority” used in conventional event schedulers.

The weighting may be associated with the event when it is arranged in the tree, e.g. be a piece of data that forms part of the event within the tree. This approach simplifies an operation of identifying a weighting, and enables other components of the (wireless) device to control the value of the weighting, e.g. when submitting the event to the event scheduler.

In other examples, a weighting may only be assigned to an event if it conflicts with another desired event. Assigning a weighting may comprise consulting a dataset or database (e.g. a look-up table) that matches events to appropriate weightings. This approach may reduce a size of the tree-based data structure (by reducing an amount of data held by the tree).

In some examples, the lower the weighting, the less likely that the associated event will be selected (e.g. the lower the perceived importance or priority of that event), and the higher the value of the weighting, the more likely that the associated event will be selected (e.g. the greater the perceived importance or priority of that event). In other examples, the lower the value of the weighting, the more likely that the associated event will be selected, and the higher the value of the weighting, the less likely that the associated event will be selected.

In some examples, the weighting may have a value between 0 and 255 or 1 and 256 (i.e. possible values for weightings fall between 0 and 255 or 1 and 256). However, the skilled person would readily contemplate other possible ranges for the weighting, e.g. between: 0 and 511; 1 and 512; 0 and 1023; 1 and 1024; 0 and 100; 1 and 100 and so on.

When each desired event has a weighting, resolving conflicting desired events may comprise performing a weighted probabilistic scheduling algorithm to select the event to be performed by the wireless communication module using the weightings of each event. It will be apparent that the weighted probabilistic scheduling algorithm may be configured to be more likely to select events having a weighting that indicates a higher probability that the event will be selected than events having a weighting that indicates a lower probability that the event will be selected.

Thus, conceptually, the weighted probabilistic scheduling algorithm will be more likely to select a desired event that is perceived as being more important, than a desired event that is perceived as being less important. The weighting thereby represents a perceived importance (e.g. to an ongoing communication process or a communication protocol).

One suitable example of a weighted probabilistic scheduling algorithm is a lottery scheduling algorithm. In this scenario, each weighting represents a number of tickets (a “ticket value”) for the lottery scheduling algorithm. Thus, the greater the weighting, the greater the likelihood that the desired event will be selected as the event to be performed by the wireless communication module (if it conflicts with another event).

One example of a lottery scheduling algorithm (which selects one of a plurality of conflicting desired events) is performed by generating a random number between 0 and the total number of tickets (the sum of all ticket values) of the conflicting desired events. The conflicting desired events are ordered in a list. The lottery scheduling algorithm then moves sequentially through the list, calculating an accumulated sum of the ticket values. The conflicting desired event that causes the accumulated sum to reach or exceed the random number is selected as the event to be performed by the wireless communication module.

The conflicting desired events may be ordered in the list using a pseudorandom ordering approach, ordering by number of tickets (or weightings), ordering by desired initiation time, or ordering (if present) by order of priority. Other suitable mechanisms for ordering a list of desired events would be apparent to the skilled person.

Other mechanisms for performing a (weighted) probabilistic scheduling approach could be envisaged by the skilled person.

It will be apparent that the above process of using a probabilistic scheduling approach is not necessary if there are no conflicting desired events.

For example, if there is only a single desired event having a desired initiation time falling within the particular period of time, the event scheduler may simply select the single desired event as the event to be carried out by the wireless communication module.

As another example, if there is no desired event having a desired initiation time falling within the first period of time, the event scheduler may indicate that no event is to be initiated or scheduled for that particular period of time.

If a conflicting desired event is not selected by the event scheduler, then an indication that the event was rejected may be provided to the component that provided the desired event to the event scheduler (e.g. to the stack module 130). This may be performed via a call-back function. Moreover, a “non-selected” or rejected event may be removed/deleted from the event scheduler.

The other component (that originally provided the rejected event) may choose to re-insert the rejected event into the event scheduler. This decision may be made based on a desired frequency of performing the event (e.g. to reinsert the event at a next desired time), based on information received from the event scheduler indicating free slots or based on an urgency of the desired event (e.g. to reinsert the event for a immediately subsequent period of time).

For example, the rejection provided by the event scheduler may include an indication of the earliest suitable time that the event could be rescheduled (e.g. by the event scheduler determining a next free slot based on existing desired events in the dataset). The other component 130 may choose to agree with the next free slot.

Other approaches to handling rejected events would be apparent to the skilled person.

In some examples, the event scheduler 110 and/or the module that submits the desired event to the event scheduler (such as the stack module 130) may be configured to modify a weighting (if present) of the desired event based on a number of rejections, a time since last performance of the event and/or a selection frequency of the desired event.

In particular, if an event is repeatedly rejected and/or not selected, the weighting may be modified to make the event more likely to be selected by a probabilistic selecting algorithm.

Thus, if an event is repeatedly not selected (i.e. rejected) by the event scheduler, it may be made increasingly more likely to be selected. Although the proposed probabilistic scheduling algorithm, as a whole, reduces the likelihood that an event will never be selected, this further approach can further reduce the likelihood that an event will never be selected, thereby further reducing the likelihood of event starvation. In particular, the weighting modification approach can increase a likelihood that an event that needs to be performed will be selected.

Thus, in some embodiments, the event scheduler may be configured to monitor a time since last performance of a desired event by the wireless communication module; and in response to the time exceeding a predetermined value, modify the weighting of the desired event to increase the likelihood that it will be selected by the weighted probabilistic scheduling algorithm.

In some embodiments, the event scheduler may be configured to monitor a number of times that an event has been rejected, and in response to the number of times exceeding a predetermined value, modify the weighting of the desired event to increase the likelihood that it will be selected by the weighted probabilistic scheduling algorithm.

The event scheduler may perform this weight-modification process on only a subset of possible events to be scheduled. For instance, events to be scheduled may be accompanied with a flag that indicates whether a weighting of the event is to be modified if it has not been scheduled within a predetermined amount of time and/or has been rejected a predetermined number of times.

As previously explained, the wireless communication module 120 is configured to carry out or perform events selected by the event scheduler, e.g. using an antenna 125 and/or other wireless communication hardware.

Preferably, the wireless communication module is embodied entirely as hardware.

Thus, the wireless communication module 120 may be configured to receive an indication of a selected event from the event scheduler 110, and carry out the scheduled event.

In some circumstances, the wireless communication module 120 may be configured to ask or request the event scheduler 110 to select an event to be performed during a particular period of time. This process may be carried out periodically, such as at some predetermined clocking frequency (e.g. between every 500 μs to 10 ms), or in response to the wireless communication module completing an event.

In particular, the wireless communication module 120 may ask the event scheduler 110 to select or indicate an event to be performed during a future period of time (e.g. a period of time beginning at between 1 ms and 10 ms in the future).

Accordingly, the event scheduler 110 may be configured to respond to a request from the wireless communication module to select an event to be performed during the indicated future period of time.

The wireless communication module may operate according to a clocking system, in which, during each clock cycle, it performs a particular event. Some events may occupy more than one clock cycle. The wireless communication module may be configured to ask the event scheduler to select an event to be performed during each clock cycle (which thereby represents a particular time period). This request can be performed in advance (e.g. between 1-2 clock cycles in advance of when the event selected by the event scheduler may be performed).

In other circumstances, the event scheduler 110 may itself iteratively indicate an event to be performed (e.g. without prompting by the wireless communication module 120). Thus, the clock for defining when an indication of an event is provided to the wireless communication module 120 may be controlled by the event scheduler 110.

The event scheduler 110 may select or indicate an event to be performed by the wireless communication module 120 independently of an ongoing event performed by the wireless communication module. This decreases a complexity of the event scheduler.

It is possible that some events performed by the wireless communication module take a period of time to complete, e.g. more than one clock cycle of the wireless communication module. Thus, if a wireless communication module periodically requests the event scheduler to select an event at some future point in time (e.g. according to some clocking system) or the event scheduler periodically or otherwise independently indicates events to be performed by the wireless communication module, the event scheduler may indicate an event to be initiated at a time when the wireless communication module is still performing an ongoing event.

The wireless communication module 120 may be adapted to further account for such a conflict. In other words, the wireless communication module 120 may be configured to resolve a conflict between an ongoing event and an indication that another event wishes to be initiated.

In particular, each event may be associated with a priority value (e.g. a value indicating the relative/perceived importance of the event, e.g. to some other component or according to a communication protocol). This may be identical to the previously described weighting for improved data storage efficiency, or a separate value for improved flexibility and granularity.

Purely by way of example, a scan event (for identifying potential new wireless connections or communication channels) may have a lower priority than a maintenance event (for maintaining existing wireless communication channels). As another example, a communication event (for communicating to another wireless device) may have a higher priority than a scan event.

The wireless communication module may be configured to compare a priority value of an ongoing event with a priority value of an event indicated by an event scheduler.

If the ongoing event has a higher priority value than the event indicated by the event scheduler (or is otherwise determined to be of a greater priority), the wireless communication module may continue with the ongoing event. The wireless communication module may also indicate that an event was rejected (e.g. by providing such an indication to the component of the wireless device that asked the desired event to be carried out).

If the ongoing event has a lower priority value than the event indicated by the event scheduler (or is otherwise determined to be of a lower priority), the wireless communication module may abort or suspend the ongoing event, and perform the event indicated by the event scheduler.

Any suspended events may be restarted or continued once the event indicated by the event scheduler completes and/or if the wireless communication module is not performing another event (e.g. in response to a further indication from the event scheduler).

If the priority values are the same (or the events are otherwise determined to be of the same priority), then the ongoing event may be continued. This embodiment may be useful in reducing the likelihood that an ongoing event will simply be restarted with a new iteration of the event (e.g. as there is an increased probability that an event having the same priority as an ongoing event will be another iteration of the same event).

In other embodiments, the event indicated by the event scheduler may instead be performed. The choice may be dependent upon implementation details.

In this way, a priority-based decision can be made to determine whether to continue the ongoing event or whether to instead perform the event indicated by the event scheduler. In combination with the probabilistic approach to event selection by the event scheduler, which ensures that low priority events can still be scheduled, this approach ensures that high priority events are not blocked from running by long-running low-priority events.

The proposed approach effectively results in the wireless communication itself performing some of the scheduling process, thereby simplifying a process to be performed by the event scheduler.

Of course, if there is no ongoing event, then the wireless communication module may simply carry out the event selected by the event scheduler.

If the event scheduler does not indicate an event to be performed (e.g. if there are no desired events having an initiation time falling within the upcoming period of time), then the wireless communication module 120 may continue with an ongoing event or, if there is no ongoing event or the ongoing event ends, idle.

From the foregoing, it will be clear that the present disclosure provides a mechanism for resolving a problem of conflicting desired events. In particular, the present disclosure proposes an efficient event scheduler that employs a tree-based structure for organising/arranging desired events and uses a (preferably weighted) probabilistic mechanism for resolving conflicting desired events.

This approach results in a highly efficient event scheduler, that schedules desired events in a fair manner, thereby providing the opportunity for “low-priority” events, e.g. events having a low weighting, to be performed, reducing a likelihood of event starvation.

The present disclosure also recognises that use of a probabilistic scheduling algorithm is acceptable for use with wireless communication events. This is because wireless communication standards usually permit wireless communication channels to remain “open” even if a number of maintenance events are missed. This is historically used to account for noisy or lossy channels or communication mediums, but is here exploited to instead allow “low-priority” events to be carried out.

Thus, it is possible to occasionally skip “high-priority” events (e.g. maintaining an open communication channel), provided that (on average) the events are performed a minimum number of times. This recognition is used to allow “low-priority” events to be carried out, without affecting the underlying operation of “high-priority” events.

It is therefore recognised that using a probabilistic approach to select events to be carried out by a wireless communication module is unlikely to cause a (significant or noticeable) deterioration in the reliability of the wireless communication module, whilst increasing the speed/regularity at which “low-priority” events are performed.

Thus, it is an underlying recognition of the present invention that a probabilistic scheduling algorithm can be employed in the context of wireless communications, as the nature of wireless communication protocols means that occasionally missing high-priority events does not necessarily have an adverse effect on the operation of the wireless communication module.

For the sake of completeness, it is noted that the event scheduler 110 may store the tree-based data structure in a store 140. The event scheduler 110 may be configured to (re)construct and/or modify the tree-based data structure based on received incoming desired events from other components of the (wireless) device.

The event scheduler may be configured to (re)construct the tree-based structure using any suitable tree-based algorithm, such as a red-black tree algorithm or an AVL tree algorithm.

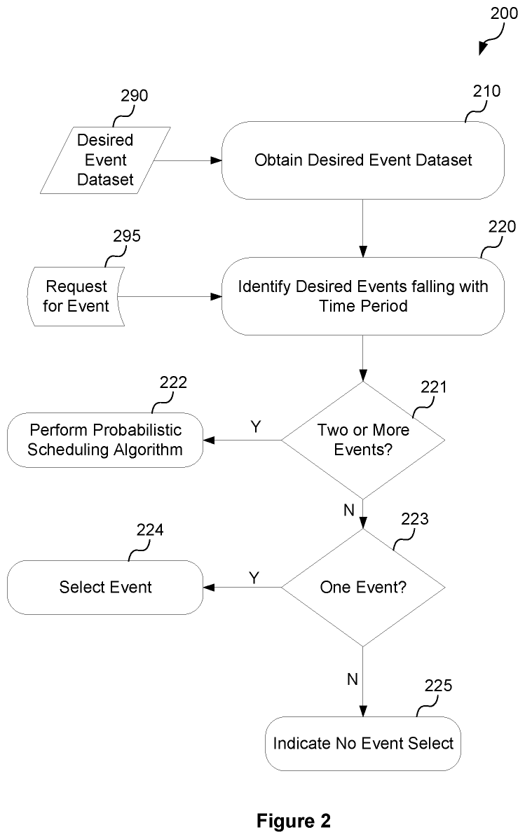

FIG. 2 is a flow chart illustrating a method 200. The method is for selecting an event to be carried out by a wireless communication module during a first (i.e. particular) period of time. The method 200 may be carried out by the event scheduler 110 described with reference to FIG. 1.

The method 200 comprises a step 210 of obtaining a desired event dataset 290 comprising two or more desired events arranged in a tree-based data structure based on a desired initiation time for each desired event. The two or more desired events may comprise at least two desired events, e.g. at least five desired events, e.g. at least ten desired events.

The desired event dataset has been previously described. The event scheduler may be configured to construct or generate the desired event dataset 290 based on received or incoming desired events (e.g. from other components of the device, such as a stack module). In some examples, step 210 may comprise obtaining the desired event dataset from a store.

The method 200 further comprises a step 220 of processing the desired event dataset to identify which, if any, desired events have a desired initiation time falling within the first period of time.

In this way, the tree may be searched to identify events that fall within the first period of time, i.e. events that wish to be initiated during the first period of time. The first period of time may be identified via a request 295 from the wireless communication module (or otherwise indicated).

The method identifies, in a determination step 221, whether two or more desired events wish to be performed during the first period of time, i.e. whether the desired initiation times fall within the first period of time.

In response to two or more desired events having a desired initiation time falling within the first period of time, the method performs a step 222 of performing a probabilistic scheduling algorithm on the identified desired events to select the event to be carried out by the wireless communication module.

If there are less than two desired events, the method may perform a step 223 of determining whether there is only one desired event having a desired initiation time falling within the first period of time.

In response to a single event having a desired initiation time falling within the first period of time, the method moves to step 224 of selecting that event as the event to be performed by the wireless communication module.

In response to no event having a desired initiation time falling within the first period of time, the method moves to step 225 of selecting no event to be performed by the wireless communication module.

The method 200 may be iterative repeated, e.g. for consecutive periods of time (or clock cycles of the wireless communication module). In this way, the method may be iteratively repeated to continually select a next event to be performed by the wireless communication module.

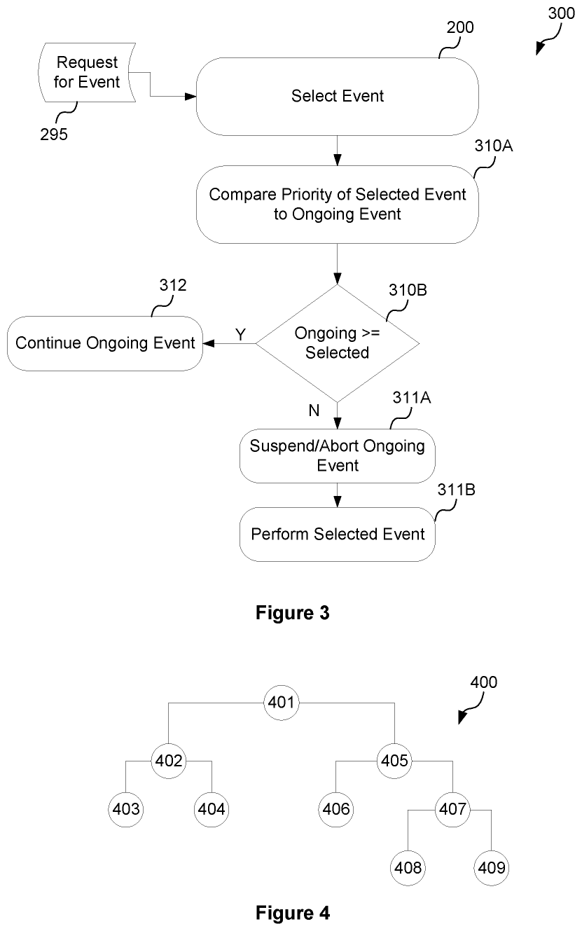

FIG. 3 is a flow chart illustrating a method 300 to be carried out by a wireless communication system.

The method 300 comprises performing the method 200 previously described to identify or select an event to be performed by the wireless communication module during a particular period of time.

The method 200 may be triggered in response to a request (from the wireless communication module) for an indication of an event to be performed during a certain period of time (which acts as the particular period of time), such as some future period of time.

In other examples, the method 200 may be periodically or iteratively performed (e.g. according to some predetermined clock).

The selected event is then passed to the wireless communication module.

In some examples (not illustrated in FIG. 3), the wireless communication module may then simply perform the selected event.

In some examples (illustrated in FIG. 3), the wireless communication may (if already performing an ongoing event) compare a priority value of the selected event to the ongoing event in a comparison step 310A and decision step 310B.

If the priority value of the selected event is greater than the ongoing event, the ongoing event may be suspended and/or aborted in a step 311A, and the selected event may be performed in a step 311B.

If the priority value of the selected event is less than the ongoing event, the ongoing event may be continued in a step 312. The selected event may, for example, be rejected and an indication of the rejection passed to the module that passed the original event to the event scheduler.

FIG. 4 illustrates a structure of a tree-based data structure 400 for use by the event scheduler. In particular, desired events can be structured within the tree based on their desired initiation time. In this way, events having similar initiation times are grouped or clustered together in the tree.

Each node 401-409 represents a different desired event to be carried out by the wireless communication module.

This facilitates low complexity searching of the tree for desired events that fall within a particular period of time. In particular, events having a similar initiation time will be clustered together, so that identification of the desired events requires fewer steps. Moreover, the tree-based structure allows low complexity navigation to an event falling within the particular period of time. Thus, use of a tree-based structure provides a more efficient approach for identifying potentially conflicting events to thereby provide a more efficient event scheduler. The combination of a tree-based structure for the desired events and a probabilistic scheduling algorithm provides a highly efficient and fair (i.e. resulting in reduced event starvation) event scheduling mechanism.

Preferably, the tree-based data structured is a balanced or semi-balanced tree. This further reduces the complexity of searching the tree for events that fall within the particular period of time.

A layout processing system configured to determine positional information for logical components of a circuit derived from the integrated circuit description so as to generate a circuit layout description of an integrated circuit embodying the wireless communication system; and

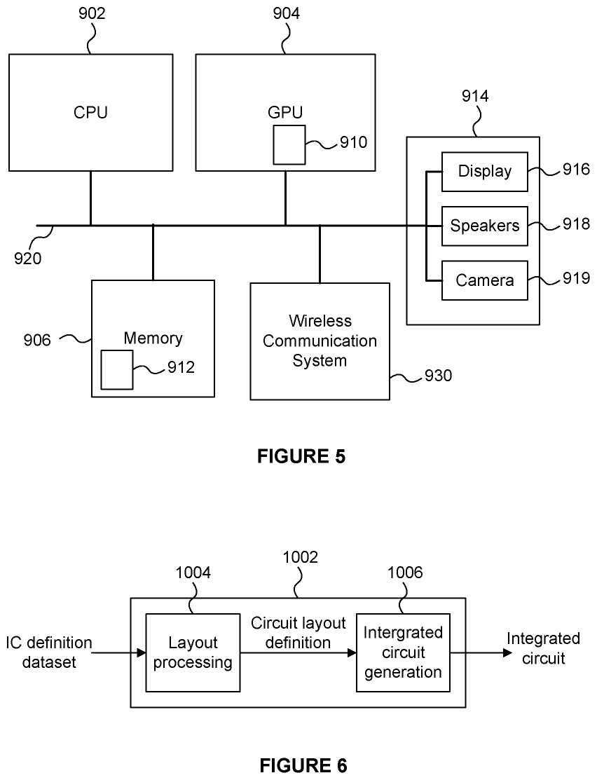

FIG. 5 shows a computer system in which the wireless communication systems described herein may be implemented. The computer system comprises a CPU 902, a GPU 904, a memory 906 and other devices 914, such as a display 916, speakers 918 and a camera 106. The computer system also comprises a wireless communication system 930, corresponding to the wireless communication system 100. The components of the computer system can communicate with each other via a communications bus 920. A store 912 (corresponding to store 140) may be implemented as part of the memory 906.

While FIG. 5 illustrates one implementation of a wireless communication system, it will be understood that a similar block diagram could be drawn for an artificial intelligence accelerator system—for example, by replacing either the CPU 902 or the GPU 904 with a Neural Network Accelerator (NNA), or by adding the NNA as an additional unit.

The systems illustrated by FIGS. 1 and 5 are shown as comprising a number of functional blocks. This is schematic only and is not intended to define a strict division between different logic elements of such entities. Each functional block may be provided in any suitable manner. It is to be understood that intermediate values described herein as being formed by a system need not be physically generated by the system at any point and may merely represent logical values which conveniently describe the processing performed by the system between its input and output.

The systems described herein may be embodied in hardware on an integrated circuit. The systems described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a (wireless communication) system configured to perform any of the methods described herein, or to manufacture a wireless communication system comprising any apparatus described herein. An integrated circuit definition dataset may be, for example, an integrated circuit description.

Therefore, there may be provided a method of manufacturing, at an integrated circuit manufacturing system, a wireless communication system as described herein. Furthermore, there may be provided an integrated circuit definition dataset that, when processed in an integrated circuit manufacturing system, causes the method of manufacturing a wireless communication system to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS (RTM) and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a wireless communication system will now be described with respect to FIG. 6.

FIG. 6 shows an example of an integrated circuit (IC) manufacturing system 1002 which is configured to manufacture a wireless communication system as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a wireless communication system as described in any of the examples herein), process the IC definition dataset, and generate an IC according to the IC definition dataset (e.g. which embodies a wireless communication system as described in any of the examples herein). The processing of the IC definition dataset configures the IC manufacturing system 1002 to manufacture an integrated circuit embodying a wireless communication system as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a wireless communication system without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 1 or 5 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 6, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations.

The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description, it will be evident to a person skilled in the art that various modifications may be made within the scope of the invention.

Any reference numerals are provided in the claims for the sake of clarity, and are non-limiting.

What is claimed is:

1. A computer-implemented method of selecting an event to be carried out by a wireless communication module during a first period of time, the computer-implemented method comprising performing, using an event scheduler, steps of:
obtaining a desired event dataset comprising two or more desired events arranged in a tree-based data structure based on a desired initiation time for each desired event;
processing the desired event dataset to identify which, if any, desired events have a desired initiation time falling within the first period of time; and
in response to two or more desired events, in the desired event dataset, having a desired initiation time falling within the first period of time, performing a probabilistic scheduling algorithm on the identified desired events to select the event to be carried out by the wireless communication module.

2. The computer-implemented method of claim 1, wherein the step of obtaining the desired event dataset comprises:
receiving one or more desired events; and
generating or modifying, using the event scheduler, a desired event dataset to include the received one or more desired events, wherein the generating or modifying of the desired event dataset is performed based on a desired initiation time for each received one or more desired events.

3. The computer-implemented method of claim 1, wherein:
each desired event is associated with a weighting that affects a probability that the said desired event will be selected by the probabilistic scheduling algorithm; and
the probabilistic scheduling algorithm uses the weighting of each of the identified desired events to select the event to be carried out by the wireless communication module.

4. The computer-implemented method of claim 3, further comprising:
monitoring a time since last performance of a desired event by the wireless communication module; and
in response to the time exceeding a predetermined value, modifying the weighting of the desired event to increase the probability that the said desired event will be selected by the probabilistic scheduling algorithm.

5. The computer-implemented method of claim 1, wherein the probabilistic scheduling algorithm is a lottery scheduling algorithm.

6. The computer-implemented method of claim 1; further comprising:
in response to only a single desired event having a desired initiation time falling within the first period of time, selecting the single desired event as the event to be carried out by the wireless communication module.

7. The computer-implemented method of claim 1, further comprising:
in response to no desired event having a desired initiation time falling within the first period of time, selecting no desired event as the event to be carried out by the wireless communication module.

8. A computer-implemented method of selecting an event to be carried out be a wireless communication module, the computer-implemented method comprising:
receiving an event request, the event request being a request for a selection of an event to be performed by the wireless communication module during a desired period of time; and
performing the method of claim 1, wherein the first period of time is the desired period of time indicated by the event request.

9. The computer-implemented method of claim 1, wherein an event is a communication task to be carried out by the wireless communication module.

10. The computer-implemented method of claim 1, wherein the wireless communication module operates according to a Bluetooth standard.

11. A computer-implemented method of controlling an event performed by a wireless communication module, the computer-implemented method comprising:
receiving, at the wireless communication module, a selection of a desired event from an event scheduler, wherein the event scheduler selects the desired event by performing the method of claim 1; and
carrying out, by the wireless communication module, the desired event indicated by the selection of the desired event.

12. A computer-implemented method of controlling an event performed by a wireless communication module, wherein each event is associated with a priority, the computer-implemented method comprising:
receiving, at the wireless communication module, a selection of a desired event from an event scheduler, wherein the event scheduler selects the desired event by performing the method of claim 1;
comparing, using the wireless communication module, a priority of the selected desired event to an ongoing event being performed by the wireless communication module;
in response to the priority of the ongoing event being greater than the priority of the selected desired event, continuing with the ongoing event; and
in response to the priority of the selected desired event being greater than the priority of the ongoing event, suspending or aborting the ongoing event and performing the selected desired event.

13. An event scheduler configured to select an event to be carried out by a wireless communication module during a first period of time, the event scheduler being configured to perform steps of:
obtaining a desired event dataset comprising two or more desired events arranged in a tree-based data structure based on a desired initiation time for each desired event;
processing the desired event dataset to identify which, if any, desired events have a desired initiation time falling within the first period of time; and
in response to two or more desired events, in the desired event dataset, having a desired initiation time falling within the first period of time, performing a probabilistic scheduling algorithm on the identified desired events to select the event to be carried out by the wireless communication module.

14. The event scheduler of claim 13, wherein the probabilistic scheduling algorithm is a lottery scheduling algorithm.

15. A wireless communication module configured to carry out one or more events to wirelessly communicate with other wireless communication modules, the wireless communication module being configured to perform steps of:
receiving a selection of a desired event from the event scheduler of claim 13; and
carrying out the desired event indicated by the selection of the desired event.

16. A wireless communication module configured to carry out one or more events to wirelessly communicate with other wireless communication modules, wherein each event is associated with a priority, the wireless communication module being configured to perform steps of:
receiving a selection of a desired event from the event scheduler of claim 13;
comparing a priority of the selected desired event to an ongoing event being performed by the wireless communication module;
in response to the priority of the ongoing event being greater than the priority of the selected desired event, continuing with the ongoing event; and
in response to the priority of the selected desired event being greater than the priority of the ongoing event, suspending or aborting the ongoing event and performing the selected desired event.

17. A wireless communication system comprising:
the event scheduler of claim 13; and
the wireless communication module of claim 15.

18. A wireless communication system configured to perform the method of claim 1.

19. The wireless communication system of claim 18, wherein at least the wireless communication module is embodied in hardware on an integrated circuit.

20. A non-transitory computer readable storage medium having stored thereon computer readable code configured to cause to be performed, when the code is run, a method of selecting an event to be carried out by a wireless communication module during a first period of time, the computer-implemented method comprising performing, using an event scheduler, the method comprising:
obtaining a desired event dataset comprising two or more desired events arranged in a tree-based data structure based on a desired initiation time for each desired event;
processing the desired event dataset to identify which, if any, desired events have a desired initiation time falling within the first period of time; and
in response to two or more desired events, in the desired event dataset, having a desired initiation time falling within the first period of time, performing a probabilistic scheduling algorithm on the identified desired events to select the event to be carried out by the wireless communication module.
